(19) United States
(12) Patent Application Publication
(10) Pub. No.: US 2002/0004386 A1
(43) Pub. Date: Jan. 10, 2002

(54) Apparatus comprising a storage device for storing performance data and method of updating this storage device

(76) Inventor: Jean-Michel Simon, Le Mans (FR)

Correspondence Address: U. S. Philips Corporation, 580 White Plains Road, Tarrytown, NY, 10591, US

(21) Appl. No.: 09/817,086

(22) Filed: Mar. 26, 2001

(30) Foreign Application Priority Data
Mar. 28, 2000 (FR) 0003904

(51) Int. Cl. H04M 3/00

(52) U.S. Cl. 455/419; 455/418; 455/425

(57) ABSTRACT

The operation of the apparatus (1) depends on data contained in a storage device (85). It often appears to be necessary to update these data. For this purpose, data are tapped contained in another storage device of another apparatus (50), preferably of the same type. Application to portable cellular telephony apparatus.

The invention relates to an apparatus of a certain type comprising a storage device for storing performance data.

The invention finds interesting applications notably in the field of mobile telephone apparatus that form part of a cellular network. In this type of apparatus many functions are defined by data contained in a memory device. It often becomes necessary to change these functions, add functions or suppress functions.

The invention also relates to a method of updating said storage device.

The invention furthermore relates to a system comprising at least two such apparatus of the same type.

Such an apparatus is known from patent document PCT WO 97/35453. For updating or for modifying the operation software of the apparatus, there is proposed in this patent document to utilize a PC type of computer, for example.

The apparatus known from this document has the drawback that the use of such a computer may present difficulties and call for a certain infrastructure. For example, a server must be provided from which the information to be updated is obtained. Furthermore, one has to know how his update program is to be started.

The present invention proposes an apparatus of the type mentioned in the preamble which avoids the necessity of using a computer.

For this purpose, such an apparatus is characterized in that it comprises updating means for updating its storage device from another apparatus of the same type.

A method of the type defined above is characterized in that said update data are tapped from another apparatus of the same type.

This method comprises the following steps: preparation of a first apparatus for producing the update data, preparation of a second apparatus for receiving the update, data transfer from the first apparatus to the second apparatus, writing update data into the storage device of the second apparatus.

A system of the type defined above is characterized in that at least a first apparatus comprises means for communicating its update data and in that at least a second apparatus comprises means for being updated with update data from the first apparatus.

These and other aspects of the invention are apparent from and will be elucidated, by way of non-limitative example, with reference to the embodiment(s) described hereinafter.

In the drawings:

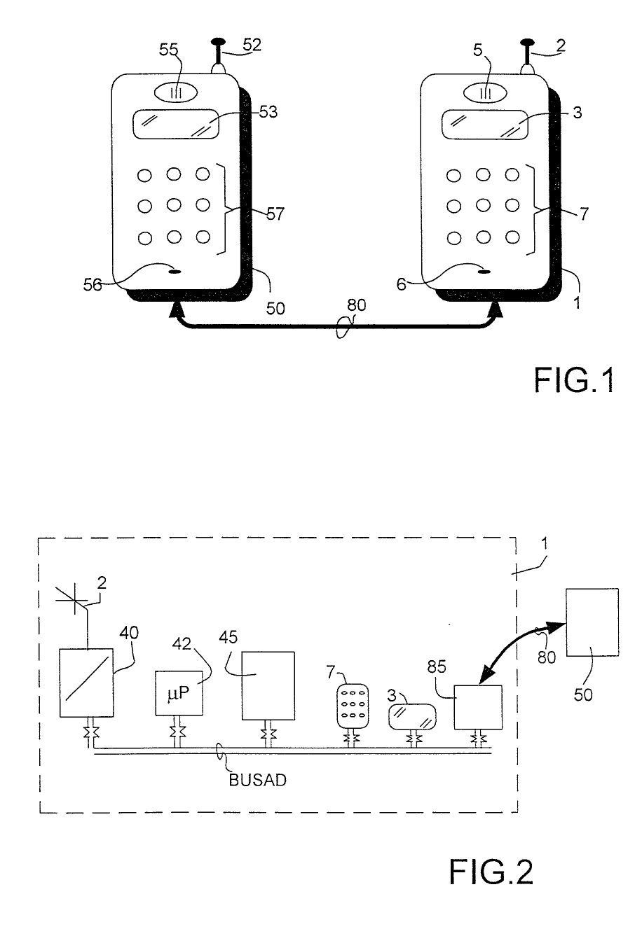

FIG. 1 shows an apparatus in accordance with the invention,

FIG. 2 shows the diagram of the apparatus of FIG. 1,

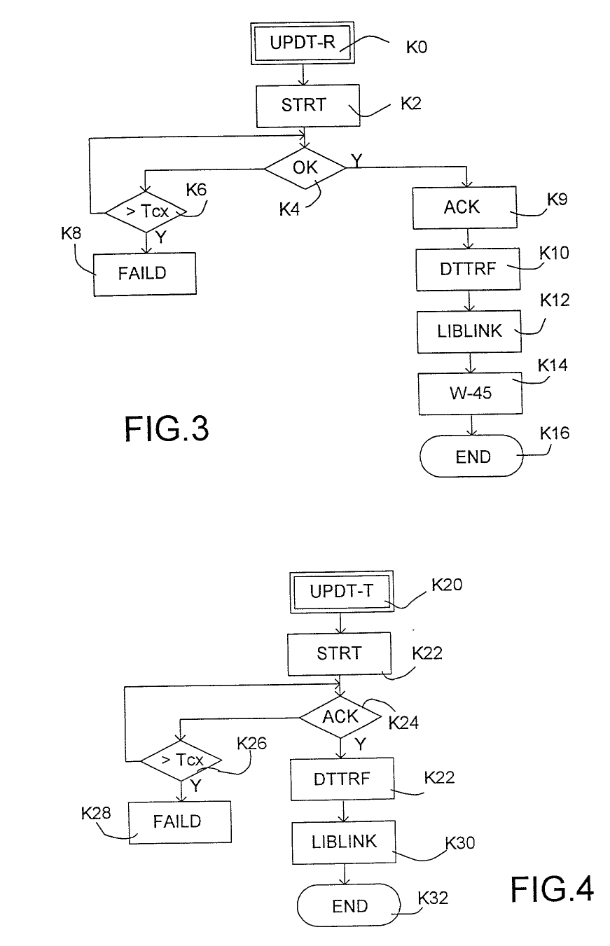

FIG. 3 shows a flow chart explaining the operation of the apparatus that receives the update,

FIG. 4 shows a flow chart explaining the operation of the apparatus that produces the update data.

FIG. 1 shows an apparatus in accordance with the invention, which is referred to as 1. This apparatus is a mobile radiotelephone intended to be connected to a cellular network. It comprises an antenna 2, a screen 3, a loudspeaker 5, a microphone 6 and a keypad 7.

FIG. 2 shows an electrical diagram of this apparatus. Reference 40 refers to the radio transceiver part. The microprocessor assembly, which manages the operation of the apparatus, is referred to as 42. This assembly 42 co-operates with a storage device 45 formed, for example, by a flash memory which contains elements which determine this operation and which may be updated. Other elements, which may not be updated, are contained either in this memory or in another memory not shown in this Figure. A common line BUSAD links the various elements of this apparatus. It may be necessary for this memory to get updates for modifying, suppressing or adding new functionalities to the apparatus.

According to the invention updating means are provided for updating this storage device 45 which operates from another apparatus 50 of the same type.

This apparatus 50 (FIG. 1) comprises like element s to apparatus 1, that is to say, an antenna 52, a screen 53, a loudspeaker 55, a microphone 5 6 and a keypad 57.

In order to carry out this update, the apparatus 1 and 50 are connected by a cable 80. This cable is connected to the apparatus by means of an interface circuit 85 which is available in the apparatus 1. Obviously, a resembling or similar interface circuit is available in apparatus 50.

FIG. 3 shows the operation of the apparatus that calls for an update. A prerequisite of this update is that the link is already in place. The start of this process is at box K0. For effecting this update, the user validates a heading of a menu provided for this purpose and displayed on the screen 3. The box K2 indicates the start of the verification process for the connection 80. This connection is then tested in box K4. For this test may be detected a preamble sequence transmitted before the update data. If this sequence is not detected, box K6 is proceeded to. This box indicates whether the time given for establishing the connection has elapsed or not. If the time has elapsed, then there is declared via a message on screen 3 that the connection is not established and the user is requested to verify this link (box K8). If one is still within the time given, the test of box K4 is returned to. When the link or the connection is declared to be established, an acknowledgement of receipt message is sent (box K9) to the apparatus that produces the update data. Then the transfer of data may be effected in box K10. At the end of this transfer the link is cleared in box K12. Then memory 45 is written (box K14), which memory contains data to be updated. The process is then terminated in box K16.

FIG. 4 shows the operation of the apparatus from which the update data are tapped. The process also starts (box K20) with the validation of a heading of a menu. The box K22, which follows, indicates the transmission of the preamble sequence already mentioned before. In box K24 a test is made whether the acknowledgement-of-receipt message has been received. If not, a test is made (box K26) of the duration in which this message has not yet been received. If this time is considered too long, the connection is declared to be impossible (box K28). If the acknowledgement of receipt is received, then the transmission of the update data can be effected (box K22). This clears the link (box K30). The process is declared to be terminated in box K32.

The link or the connection that has been discussed may be realized in various ways, for example, by a copper wire, by an infrared link or by a system known by the name of “Blue Tooth”.

1. An apparatus of a certain type comprising a storage device for storing performance data, characterized in that it comprises updating means for updating its storage device from another apparatus of the same type.

2. An apparatus as claimed in claim 1, characterized in that said updating means are formed by a serial wire link.

3. An apparatus as claimed in claim 1, characterized in that said updating means are formed by an infrared link.

4. An apparatus as claimed in claim 1, characterized in that said updating means are formed by a radio link of the type “Blue Tooth”.

5. A method of updating the operation software of an apparatus as claimed in one of the claims 1 to 4 by means of update data, characterized in that said update data are tapped from another apparatus of the same type.

6. A method as claimed in claim 5, characterized in that the updating is effected in the following steps:
preparation of a first apparatus for producing the update data,
preparation of a second apparatus for receiving the update,
data transfer from the first apparatus to the second apparatus,
writing update data in the storage device of the second apparatus.

7. A system comprising at least two apparatus of the same type as claimed in one of the claims 1 to 4, comprising means for exchanging update data, characterized in that at least a first apparatus comprises means for communicating its update data and in that at least the second apparatus comprises means updated with update data from the first apparatus.
